(19) United States
(12) Patent Application Publication
(10) Pub. No.: US 2013/0158974 A1
(43) Pub. Date: Jun. 20, 2013

(54) MODELING AND PREDICTING CONTROL SYSTEM BEHAVIOR THROUGH FAST-FORWARDING

(71) Applicants: Jason Croft, Urbana, IL (US); Ratul Mahajan, Seattle, WA (US); Madan Musuvathi, Seattle, WA (US)

(72) Inventors: Jason Croft, Urbana, IL (US); Ratul Mahajan, Seattle, WA (US); Madan Musuvathi, Seattle, WA (US)

(73) Assignee: MICROSOFT CORPORATION, Redmond, WA (US)

(21) Appl. No.: 13/325,077

(22) Filed: Dec. 14, 2011

(51) Int. Cl. G06G 7/62

(52) U.S. Cl. 703/22; 703/13

(57) ABSTRACT

Methods and systems for modeling and predicting control system behavior through fast-forwarding are provided herein. The method includes obtaining sets of equivalent inputs, time zones, and a user-defined stop time. The method also includes taking a primary checkpoint of a main instance of a control system in response to a user input. The method includes fast-forwarding the control system by generating a secondary instance from the main instance at the primary checkpoint and subjecting the secondary instance to each combination of an input from each of the sets of equivalent inputs in each time zone. The method includes taking a secondary checkpoint from the primary checkpoint for each combination. For each secondary checkpoint, the method includes fast-forwarding the control system by generating a tertiary instance from the secondary instance and subjecting the tertiary instance to each combination as long as a time does not exceed the user-defined stop time.

### BACKGROUND

Control systems are devices that interact with an environment to direct, regulate, or control the behavior of the other devices or systems in the environment through the use of control equipment. Control equipment can include sensors to measure parameters in the environment and actuators to effect changes in the environment. Due to the increasing complexity of control systems, it may be desirable to model the behavior of controls systems prior to their implementation or deployment. However, when configuring controls systems, such as those used for home automation, it is often difficult for a user to predict whether the system will behave as intended. This problem may be partially mitigated by the development of more intuitive user interfaces. However, while such user interfaces may be helpful, the effectiveness of this solution is limited by a particular user's ability to interpret information provided by the user interface.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for modeling and predicting control system behavior through fast-forwarding. The method includes obtaining sets of equivalent inputs, time zones, and a user-defined stop time within a computing environment. The method also includes taking a primary checkpoint of a main instance of a control system in response to a user input. The method includes fast-forwarding the control system by generating a secondary instance from the main instance at the primary checkpoint and subjecting the secondary instance to each combination of an input from each of the sets of equivalent inputs in each of the time zones. The method includes taking a secondary checkpoint from the primary checkpoint for each combination. For each secondary checkpoint, the method further includes fast-forwarding the control system by generating a tertiary instance from the secondary instance and subjecting the tertiary instance to each combination as long as a time does not exceed the user-defined stop time.

Another embodiment provides a system for modeling and predicting control system behavior through fast-forwarding. The system includes a processor that is adapted to execute stored instructions and a storage device that stores instructions that are executable by the processor. The instructions include an offline analysis module configured to analyze source code from a control system to infer sets of equivalent inputs and construct time zones. The instructions also include a state space exploration module configured to take a second instance from a main instance of the control system in response to a user's selection of a primary checkpoint and perform state space exploration by subjecting the second instance to an input from each of the sets of equivalent inputs in each of the time zones. The state space exploration module is further configured to take a number of additional checkpoints from the primary checkpoint for the input in each of the time zones. Additionally, for each additional checkpoint, the state space exploration module is configured to perform the state space exploration by generating a subsequent instance from the second instance and subjecting the subsequent instance to the input in each of the time zones as long as a time does not exceed a user-defined stop time.

In addition, another embodiment provides one or more non-transitory, computer-readable storage media for storing computer-readable instructions. The computer-readable instructions provide a system for modeling and predicting control system behavior when executed by one or more processing devices. The computer-readable instructions include code configured to perform state space exploration of a control system as long as a time does not exceed a user-defined stop time. This is accomplished by evaluating the control system at multiple checkpoints within each of a number of instances of the control system. Evaluating the control system at a specific checkpoint within a particular instance includes subjecting the particular instance to an input from each of a number of sets of equivalent inputs in each of a number of time zones at the specific checkpoint.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a computing system that may be used to model and predict control system behavior through a fast-forwarding procedure;

FIG. 2 is a process flow diagram showing an offline analysis method for analyzing source code of a control system within a computing environment;

FIG. 3 is a process flow diagram showing a method for taking a checkpoint in a main instance of a control system;

FIG. 4 is a process flow diagram showing a state space exploration method for fast-forwarding a control system within a computing environment;

FIG. 5 is a schematic of an exemplary implementation of the state space exploration procedure;

FIG. 6 is a process flow diagram showing a method for predicting the behavior of a control system through a fast-forwarding procedure; and

FIG. 7 is a block diagram showing a tangible, computer-readable medium 500 that stores code adapted to fast-forward control systems.

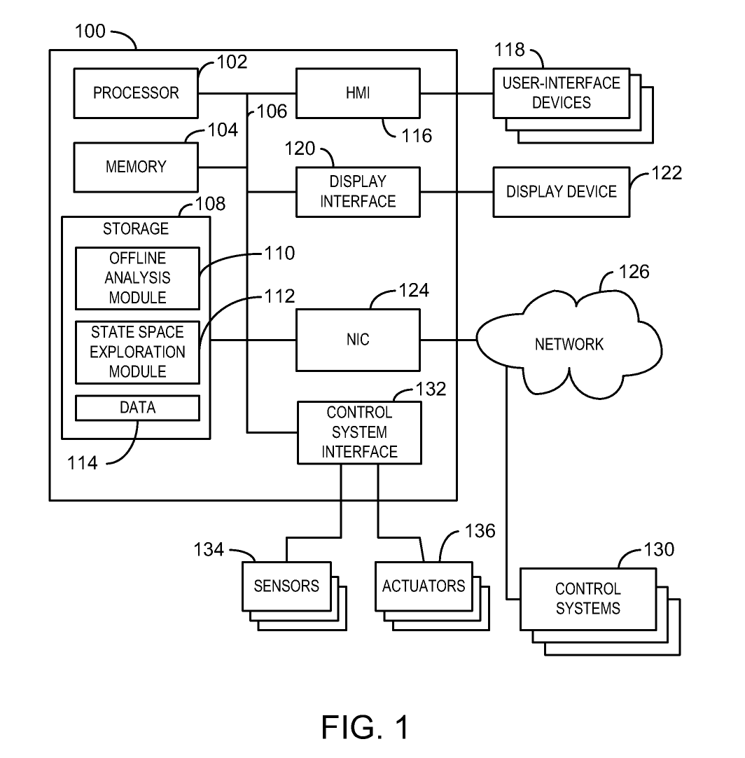

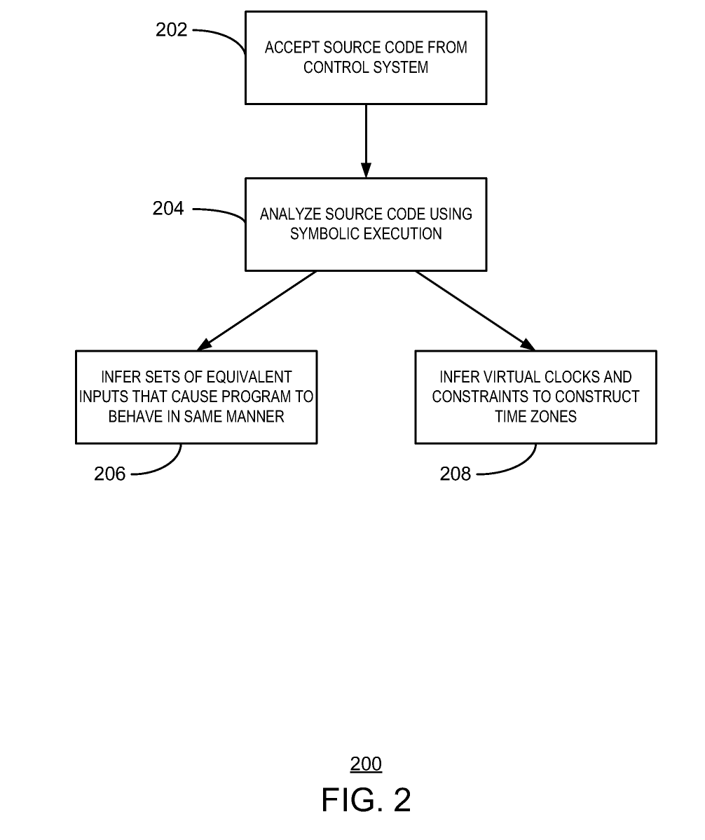

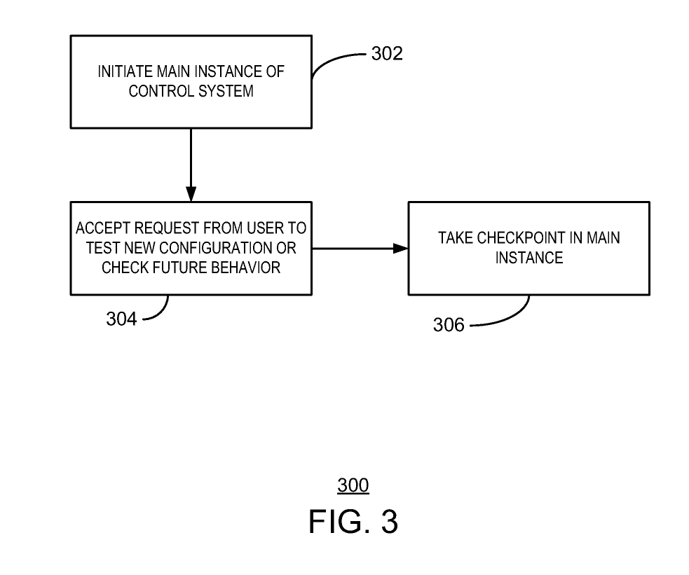

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, it is often desirable to model and predict the behavior of a control system during the implementation of the control system, or before the deployment of the control system. Therefore, embodiments disclosed herein set forth a method and system for modeling and predicting control system behavior through a fast-forwarding procedure. The fast-forwarding procedure may be implemented using state space exploration techniques. The state space exploration techniques may allow for the modeling and predicting of control system behavior through the evaluation of a state of the control system at each combination of an input from each of a number of sets of equivalent inputs and a time zone from a number of possible time zones. As used herein, a time zone is a virtual, physical, or relative time period during which a response of a control system may be modeled and predicted.

In various embodiments, the sets of equivalent inputs may be inferred using symbolic execution, while the time zones may be constructed using both symbolic execution and timed automata according to information about virtual clocks and their associated time-related constraints. The fast-forwarding procedure may be implemented in such a manner that the main instance of the control system is not affected. This may be accomplished through the creation of multiple instances of the control system, wherein the multiple instances may originate from an initial checkpoint of the main instance.

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discrete logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1 is a block diagram of a computing system 100 that may be used to model and predict control system behavior through a fast-forwarding procedure. The computing system 100 may be, for example, a mobile phone, a tablet, a desktop computer, or a laptop computer, among others. The computing system 100 may also be a server, wherein the server may be, for example, a Web server or a cloud server.

The computing system 100 may include a processor 102 that is adapted to execute stored instructions, as well as a memory device 104 that stores instructions that are executable by the processor 102. The processor 102 may be a single core processor, a multi-core processor, a computing cluster, or any number of other configurations. The memory device 104 can include random access memory (RAM), read only memory (ROM), flash memory, or any other suitable memory systems. The stored instructions executed by the processor 102 may implement a method for modeling and predicting the behavior of a control system through a fast-forwarding procedure. The processor 102 may be connected through a bus 106 to one or more input and output devices.

The computing system 100 may include a storage device 108 adapted to store an offline analysis module 110, a state space exploration module 112, and data 114. The offline analysis module 110 can be used to collect data relating to the source code of a particular control system, including data relating to sets of equivalent inputs that cause the control system to perform the same behavior and data used to construct time zones from virtual clocks and constraints. The state space exploration module 112 can be used to implement a fast-forwarding procedure in order to model and predict the behavior of control systems. The data 114 may include data collected from the offline analysis module 110, as well as results obtained from the state space exploration module 112. The storage device 108 may include a hard drive, an optical drive, a thumbdrive, an array of drives, or any combinations thereof.

A human-machine interface (HMI) 116 may connect the computing system 100 to any number of user-interface devices 118, such as a keyboard, a speaker, or a pointing device, among others. The computing system 100 may be linked through the bus 106 to a display interface 120 adapted to connect the computing system 100 to a display device 122. The display device 122 may include a computer monitor or a display screen of a mobile device, among others.

A network interface controller (NIC) 124 may be included to connect the computing system 100 through the bus 106 to a network 126. Through the network 126, the computing system 100 may be communicably coupled to a number of control systems 130. The computing system 100 may be configured to accept source code from any of the control systems 130 and utilize the source code for the fast-forwarding procedure. In various embodiments, such control systems 130 may include home automation systems, flight management systems, or industrial control systems, among many others. Further, in some embodiments, the computing system 100 may not be communicably coupled to the control systems 130 but, rather, may be used to directly implement a control system hosted within the computing system 100.

For example, the computing system 100 may include a control system interface 132 configured to directly access sensors 134 and actuators 136. The sensors 134 are configured to gather data from the environment, and may include temperature sensors, fire detectors, motion detectors, input switches, and the like. The actuators 136 are configured to make a change in the environment, and may include alarm systems, lighting, HVAC (heating, ventilation and air conditioning) systems, valves, and the like. The choice of appropriate sensors 134 and actuators 136 is based on the type of system to be controlled, e.g., a home, an industrial plant, and the like. The computing system 100 may also include any number of other components not shown in FIG. 1, or may not include all of the components shown in FIG. 1, depending on the specific application.

FIG. 2 is a process flow diagram showing an offline analysis method 200 for analyzing source code of a control system within a computing environment. As used herein, “offline” indicates that the offline analysis method 200 is performed prior to the fast-forwarding of the control system. In various embodiments, the offline analysis method 200 may be implemented by the offline analysis module 110 within the computing system 100, as discussed above with respect to FIG. 1. The offline analysis method 200 may begin at block 202 with the acceptance of source code from a control system. As previously noted, the control system may be separated from the computing environment and communicably coupled to the computing environment through a network, or may be located within the computing environment.

At block 204, the source code of the control system may be analyzed using symbolic execution. As used herein, “symbolic execution” refers to the analysis of programs by tracking symbolic values rather than actual values. For example, symbolic execution may be used to determine whether certain inputs take the same path or different paths through a program. In various embodiments, symbolic execution may be used to infer inputs that drive the control system to different paths. Specifically, symbolic execution may be used to infer thresholds that cause the control system to behave differently.

At block 206, sets of equivalent inputs that cause the control system to behave in the same manner may be inferred. In various embodiments, the sets of equivalent inputs may be inferred from the thresholds determined using symbolic execution at block 204. Such thresholds may define execution branches, wherein each execution branch relates to one of the sets of equivalent inputs. The identification of sets of equivalent inputs allows for the evaluation of specific states of the control system without exploring every possible input. Further, in some embodiments, the steps of blocks 206 and 208 may be executed in parallel.

At block 208, virtual clocks and constraints may be inferred and utilized to construct time zones for the control system. In various embodiments, the virtual clocks and constraints may be inferred using symbolic execution at block 204. The virtual clocks may be used to define specific time periods during which exact time does not matter. Virtual clocks are often defined by events, which may be expressed as constraints. For example, a constraint may specify that a virtual clock is to be reset if a particular event occurs.

The time zones may be constructed from the virtual clocks and constraints using timed automata. Timed automata may be used to model and predict the behavior of a real-time system over time through the use of the system's time-related constraints. In various embodiments, for example, timed automata may be used to construct time zones that correspond to a region of interest of the source code within which exact time does not matter. In other words, the time zones may relate to a virtual time period or virtual length of time during which the specific time of occurrence of an event is irrelevant. Furthermore, the state of the control system may be altered according to the occurrence of specific events. For example, if a specific event occurs, the control system may move from a first state to a second state. Additionally, in some embodiments, the time zones may be related to relative times or physical times, depending on the specific application.

FIG. 3 is a process flow diagram showing a method 300 for taking a checkpoint in a main instance of a control system. The method may begin at block 302 with the initiation of a main instance, or thread, of the control system. In various embodiments, the control system may be included within a computing device that is controlled by a user, and the initiation of the main instance of the control system may be executed in response to input from the user. For example, the main instance may be initiated in response to a booting up of the computing device within which the control system is located. Furthermore, in some embodiments, the main instance of the control system may be continuously running, such as in home automation control systems or other high-security control systems.

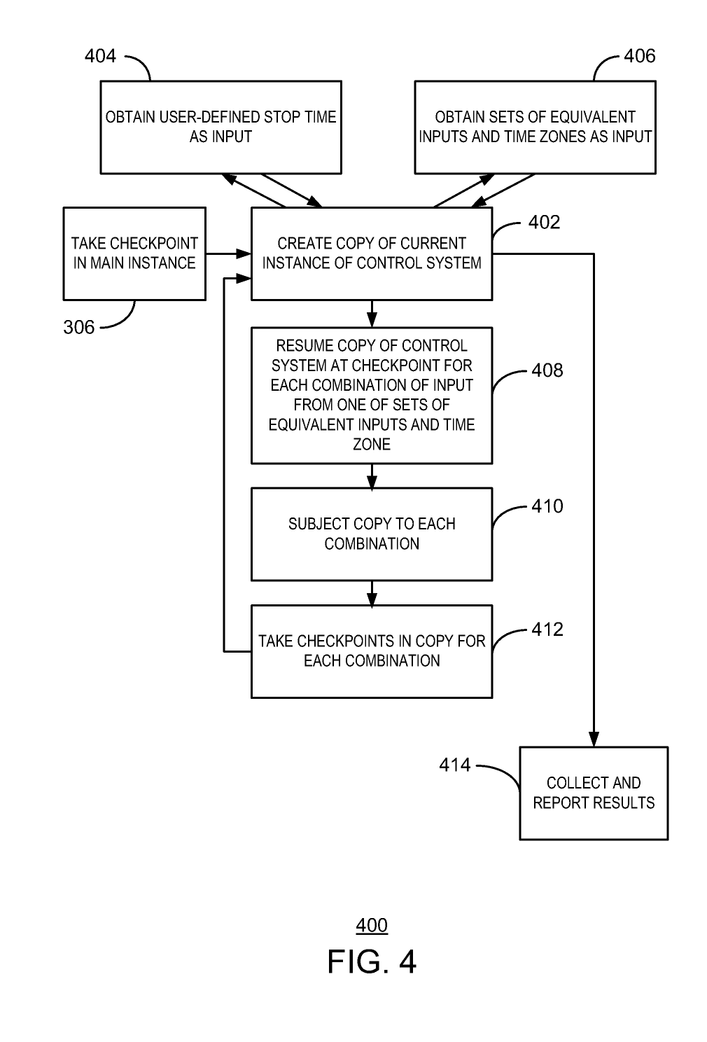

At block 304, a request to test new configurations or check the future behavior of the control system may be accepted from the user, creating a parallel thread. The main instance of the controller continues to operate on the initial thread without interruption. At block 306, a checkpoint in the main instance of the control system may be taken. In various embodiments, the checkpoint may be equal to the exact state and time of the main instance during which the request is accepted from the user. This is discussed further with respect to FIG. 4.

FIG. 4 is a process flow diagram showing a state space exploration method 400 for fast-forwarding a control system within a computing environment. In various embodiments, the state space exploration method 400 may be implemented by the state space exploration module 112 within the computing system 100, as discussed above with respect to FIG. 1. The state space exploration method 400 may begin at block 306, wherein a checkpoint in the main instance of the control system may be taken, as discussed with respect to FIG. 3. At block 402, a copy of the main instance, i.e., the “current instance,” of the control system may be created. The copy of the main instance may then be designated as the “current instance” of the control system.

At block 404, a user-defined stop, or end, time may be obtained as input to the state space exploration method 400. In various embodiments, the user-defined stop time may be a virtual time, a relative time, or a physical time, or any combination thereof, at which to end the state space exploration method 400. The user-defined stop time may be directly specified by a user of the control system. Furthermore, at block 406, sets of equivalent inputs and time zones may be obtained as input to the state space exploration method 400. In various embodiments, the sets of equivalent inputs and time zones may be determined according to the offline analysis method 200, as discussed with respect to FIG. 2.

At block 408, the copy, or current instance, of the control system may be resumed at the checkpoint for each combination of an input from one of the sets of equivalent inputs and a time zone. One input from each of the sets of equivalent inputs may be sufficient for each time zone, since the inputs within a particular set of equivalent inputs may be considered to be the same.

At block 410, the copy, or current instance, of the control system may be subjected to each combination. For each combination, the state of the copy may be observed. This information may then be utilized to fast-forward the control system based on each possible path that the control system may take.

At block 412, new checkpoints may be taken within the copy for each combination. Furthermore, in various embodiments, if a current virtual time is less than the user-defined stop time, the state space exploration method 400 may be repeated beginning at block 402. For each of the new checkpoints, copies of the current instance of the control system may be created, and the state space exploration method 400 may be executed independently for each copy. However, if the current virtual time exceeds the user-defined stop time, the state space exploration method 400 may be terminated, and the results of the state space exploration method 400 may be collected and reported at block 414. In various embodiments, the results of the state space exploration method 400 include a prediction or model of future control system behavior.

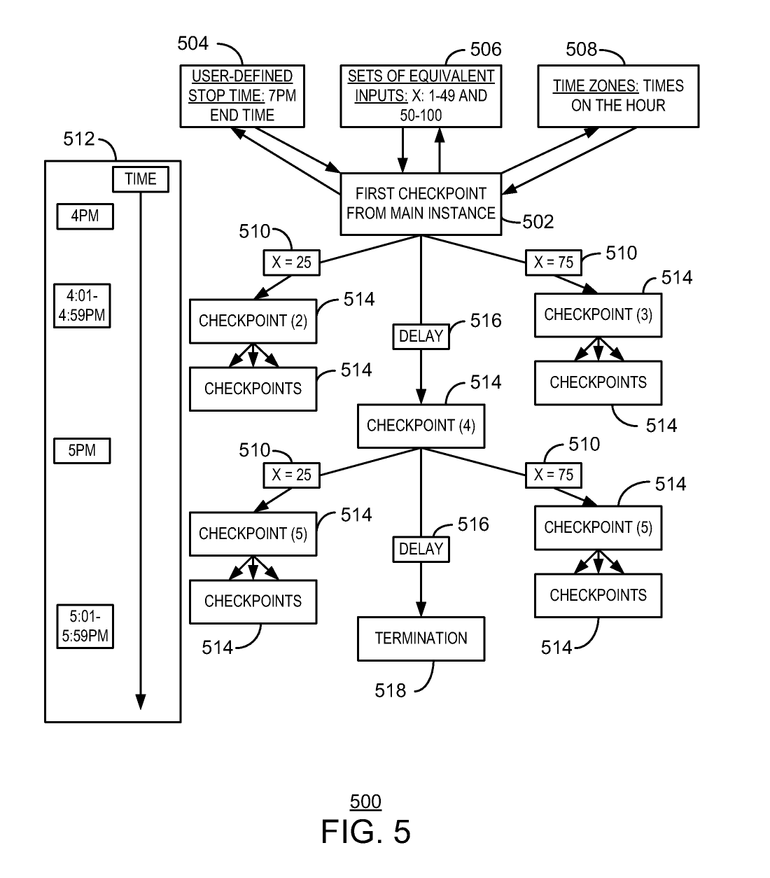

FIG. 5 is a schematic 500 of an exemplary implementation of the state space exploration procedure. Once a first checkpoint 502 of the main instance has been specified by a user of the control system, a user-defined end time 504, sets 506 of equivalent inputs, and time zones 508 may be obtained as inputs. For example, as shown in FIG. 5, the user-defined end time 504 may be 7 PM, the sets 506 of equivalent inputs may be 1-49 and 50-100, and the time zones 508 may be times on the hour. In various embodiments, the sets 506 of equivalent inputs and the time zones 508 may be inferred using symbolic execution. As used in this example, time zones 508 that are on the hour means that each exact hour is a separate time zone, and ranges between each exact hour are separate time zones. Therefore, times that are not on the hour are essentially equivalent from the perspective of the source code.

The state space exploration procedure may start from the first checkpoint 502 and attempt all of the combinations of a value 510 from each of the sets 506 of equivalent inputs in each time zone 508. For example, the value 510 from each of the sets 506 of equivalent inputs may be set equal to “X=25” and “X=75,” and modeled for each value, as shown in FIG. 5. A clock 512 may be used to keep track of the current time in order to ensure that the current time has not exceeded the user-defined end time 504. In various embodiments, the current time may be a virtual time, a physical time, or a relative time, or any combinations thereof.

For each of the combinations, a new checkpoint 514 may be taken. Furthermore, a delay 516 may be incorporated in order to allow for the transition from one time zone to the next time zone. In other words, the delay 516 simply moves the control system's notion of time from one time zone to the next. Therefore, for each given checkpoint 502 or 514, three basic operations are performed: supplying a value 510 from one of the sets 506 of equivalent inputs, such as “X=25,” as input with no movement in time, supplying a value 510 from another of the sets 506 of equivalent inputs, such as “X=75,” as input with no movement in time, and incorporating a delay 516 to the next time zone. This may allow for the systematic exploration of the system's behavior under each input in each time zone. This may be continuously repeated for an increasing number of checkpoints 514 until the user-defined end time 504 is reached, resulting in the termination 518 of the state space exploration procedure.

In various embodiments, two or more virtual clocks may be utilized, and the state space exploration procedure in the time domain may be in two or more dimensions. In other words, instead of the time zones 508 being inferred for a single virtual clock, as shown in FIG. 5, the time zones 508 may be inferred for two or more virtual clocks. The time domain may then include combinations of the time zones for each virtual clock. For example, if there are two virtual clocks, and each virtual clock has the constraint “if the time is less than 1”, then a time zone would include (0,0), (0,1), (1,0), or (1,1).

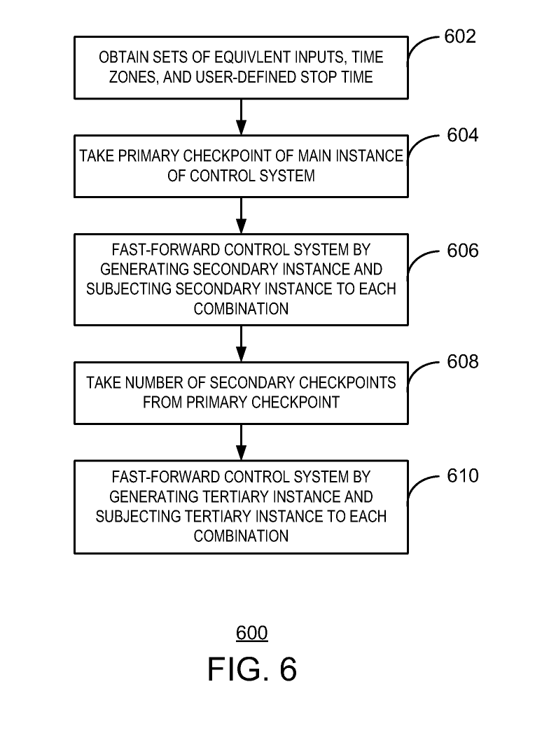

FIG. 6 is a process flow diagram showing a method 600 for predicting the behavior of a control system through a fast-forwarding procedure. The method 600 may be implemented within a computing environment, such as the computing system 100 described with respect to FIG. 1. In some embodiments, the fast-forwarding procedure is a state space exploration procedure that may be utilized to predict future control system behavior. This may be accomplished by fast-forwarding multiple instances of the control system at multiple checkpoints, wherein the multiple instances may be generated from a main instance of the control system at a specific checkpoint.

The method begins at block 602 with the obtaining of sets of equivalent inputs, time zones, and a user-defined stop time. The sets of equivalent inputs may be determined using an offline analysis module, while the user-defined stop time may be directly specified by a user of the computing environment. In various embodiments, determining the sets of equivalent inputs may include analyzing source code from the control system to infer the sets of equivalent inputs using symbolic execution. Determining the time zones may include analyzing source code from the control system to infer virtual clocks and associated constraints, and utilizing the virtual clocks and associated constraints to construct the time zones using symbolic execution and timed automata techniques. The user-defined stop time may be the time at which to end the state space exploration of the control system, as specified by a user of the control system. The user-defined stop, or end, time may be specified as a virtual time, a relative time, or a physical time, or any combinations thereof. The sets of equivalent inputs may be sets of inputs for which a state of the control system is unchanged. The time zones may include virtual lengths of time, physical lengths of time, or relative lengths of time during which a specific time is irrelevant.

At block 604, a primary checkpoint of the main instance of the control system may be taken. The primary checkpoint may be taken based on direct input from a user of the control system, or of the computing environment within which the control system is being analyzed. After the checkpoint has been taken, the main instance of the control system may continue to run uninterruptedly.

At block 606, the control system may be fast-forwarded by generating a secondary instance of the control system from the main instance and subjecting the secondary instance to each combination of an input from each of the sets of equivalent inputs in each of the time zones. In various embodiments, subjecting the primary checkpoint to each combination includes observing a predicted state of the control system at the input from each of the sets of equivalent inputs in each of the time zones.

At block 608, a number of secondary checkpoints may be taken from the primary checkpoint. In various embodiments, a secondary checkpoint may be taken for each combination of an input from each of the sets of equivalent inputs in each of the time zones.

At block 610, the control system may be fast-forwarded by generating a tertiary instance of the control system from the secondary instance for each secondary checkpoint and subjecting each of the tertiary instances to each combination of an input from each of the sets of equivalent inputs in each of the time zones. In various embodiments, subjecting each of the secondary checkpoints to each combination includes observing a predicted state of the control system at the input from each of the sets of equivalent inputs in each of the time zones. This step of the method 600 may be carried out as long as a current time does not exceed the user-defined stop time. In some embodiments, the current time may be a virtual time, a physical time, or a relative time, or any combinations thereof.

In various embodiments, the method 600 may also include taking an additional checkpoint from the secondary checkpoint for each combination. The control system may then be fast-forwarded for each additional checkpoint by generating an additional instance of the control system from the tertiary instance and subjecting the additional instance to each combination as long as the time does not exceed the user-defined stop time. Furthermore, these steps may be repeated for any number of subsequent checkpoints and instances of the control system until the user-defined end time is reached.

FIG. 6 is not intended to indicate that the method 600 is to include all of the steps 602, 604, 606, 608, and 610. Additionally, the method 600 may include any number of additional steps not shown in FIG. 6, according to the specific application. For example, the results from the fast-forwarding of the control system may be output to a computing system or storage device, or displayed to the user. The results may include a model or prediction of future control system behavior. Such a model may be utilized by the user to determine the likely behavior of the control system at some point in the future.

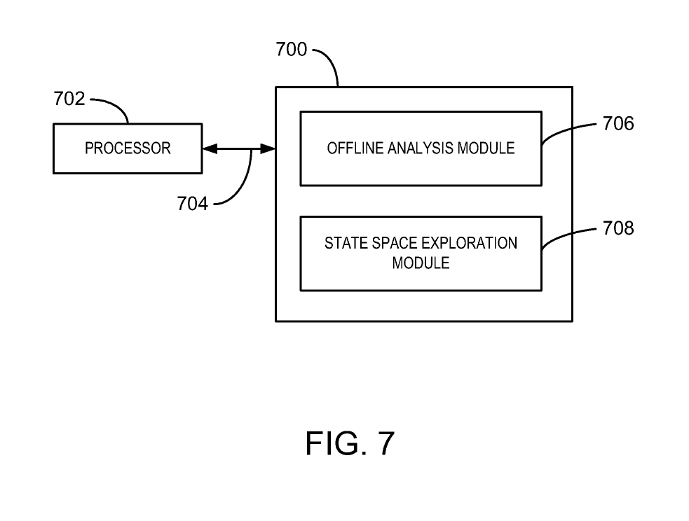

FIG. 7 is a block diagram showing a tangible, computer-readable medium 700 that stores code adapted to fast-forward control systems. In various embodiments, such fast-forwarding may allow for the prediction of a control system's behavior at some point in the future. The tangible, computer-readable medium 700 may be accessed by a processor 702, for example, over a computer bus 704. Furthermore, the tangible, computer-readable medium 700 may include code configured to direct the processor 702 to perform the steps of the current method.

The various software components discussed herein may be stored on the tangible, computer-readable medium 700, as indicated in FIG. 7. For example, an offline analysis module 706 may be configured to analyze source code from a control system to infer sets of equivalent inputs and construct time zones. A state space exploration module 708 may be configured to perform state space exploration of the control system by evaluating the control system at multiple checkpoints within each of a number of instances. In various embodiments, the evaluation of the control system at a specific checkpoint within a particular instance includes subjecting the particular instance to an input from each of the sets of equivalent inputs in each of the time zones and observing the obtained results. In some embodiments, this evaluation may be continuously executed until a time exceeds a user-defined end time. Further, the tangible, computer-readable medium 700 may also include any number of additional software components not shown in FIG. 7.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for modeling and predicting control system behavior through fast-forwarding, comprising:
obtaining sets of equivalent inputs, time zones, and a user-defined stop time within a computing environment;
taking a primary checkpoint of a main instance of a control system in response to a user input;
fast-forwarding the control system by generating a secondary instance from the main instance at the primary checkpoint and subjecting the secondary instance to each combination of an input from each of the sets of equivalent inputs in each of the time zones;
taking a secondary checkpoint from the primary checkpoint for each combination;
for each secondary checkpoint, fast-forwarding the control system by generating a tertiary instance from the secondary instance at the secondary checkpoint and subjecting the tertiary instance to each combination as long as a time does not exceed the user-defined stop time.

2. The method of claim 1, comprising:
taking an additional checkpoint from the secondary checkpoint for each combination; and
for each additional checkpoint, fast-forwarding the control system by generating an additional instance from the tertiary instance and subjecting the additional instance to each combination as long as the time does not exceed the user-defined stop time.

3. The method of claim 1, comprising outputting results from the fast-forwarding of the control system, wherein the results comprise a model of future control system behavior.

4. The method of claim 1, wherein obtaining the sets of equivalent inputs comprises analyzing source code from the control system to infer the sets of equivalent inputs using symbolic execution.

5. The method of claim 1, wherein obtaining the time zones comprises:
analyzing source code from the control system to infer virtual clocks and associated constraints; and
utilizing the virtual clocks and associated constraints to construct the time zones using symbolic execution and timed automata techniques.

6. The method of claim 1, comprising allowing the main instance of the control system to continue running without interruption.

7. The method of claim 1, wherein subjecting the primary checkpoint and each secondary checkpoint to each combination comprises observing a predicted state of the control system at the input from each of the sets of equivalent inputs in each of the time zones.

8. The method of claim 1, comprising terminating the fast-forwarding of the control system if the time exceeds the user-defined stop time.

9. The method of claim 1, wherein the time comprises a virtual time, a physical time, or a relative time, or any combinations thereof.

10. The method of claim 1, wherein fast-forwarding the control system comprises performing a state space exploration procedure to model a future behavior of the control system.

11. A system, comprising:
a processor that is adapted to execute stored instructions; and
a storage device that stores modules that are executable by the processor, the modules comprising:
an offline analysis module configured to analyze source code from a control system to infer sets of equivalent inputs and construct time zones; and
a state space exploration module configured to:
take a second instance from a main instance of the control system in response to a user's selection of a primary checkpoint;
perform state space exploration by subjecting the second instance to an input from each of the sets of equivalent inputs in each of the time zones;
take a plurality of additional checkpoints from the primary checkpoint for the input in each of the time zones; and
for each additional checkpoint, perform the state space exploration by generating a subsequent instance from the second instance at the additional checkpoints and subjecting the subsequent instance to the input in each of the time zones as long as a time does not exceed a user-defined stop time.

12. The system of claim 11, wherein the offline analysis module is configured to analyze the source code to infer the sets of equivalent inputs using symbolic execution.

13. The system of claim 11, wherein the offline analysis module is configured to:
analyze the source code to infer virtual clocks and time constraints; and
construct the time zones from the virtual clocks and the time constraints using symbolic execution and timed automata.

14. The system of claim 11, wherein the user-defined stop time comprises a virtual time, a relative time, or a physical time, or any combinations thereof, at which to end the state space exploration of the control system, as specified by a user of the control system.

15. The system of claim 11, wherein the sets of equivalent inputs comprise sets of inputs for which a state of the control system is unchanged.

16. The system of claim 11, wherein the time zones comprise virtual lengths of time, physical lengths of time, or relative lengths of time during which a specific time is irrelevant.

17. The system of claim 11, wherein the state space exploration module is configured to output results of the state space exploration to a user of the control system.

18. The system of claim 17, wherein the results of the state space exploration comprise a prediction or a model of control system behavior.

19. The system of claim 11, wherein the state space exploration of the control system comprises a fast-forwarding of a copy of the main instance of the control system.

20. One or more non-transitory, computer-readable storage media for storing computer-readable instructions, the computer-readable instructions providing a system for modeling and predicting control system behavior when executed by one or more processing devices, the computer-readable instructions comprising code configured to:
perform state space exploration of a control system as long as a time does not exceed a user-defined stop time by evaluating the control system at multiple checkpoints within each of a plurality of instances of the control system, wherein evaluating the control system at one of the checkpoints within one of the instances comprises subjecting the one instance to an input from each of a plurality of sets of equivalent inputs in each of a plurality of time zones at the one checkpoint, the multiple checkpoints generated by evaluating the control system at a primary checkpoint within a main instance of the control system, wherein evaluating the control system at the primary checkpoint within the main instance comprises subjecting the main instance to the input from each of the sets of equivalent inputs in each of the time zones at the primary checkpoint, a delay being incorporated to transition between the time zones.
